(19) United States
(12) Patent Application Publication
(10) Pub. No.: US 2021/0308750 A1
(43) Pub. Date: Oct. 7, 2021

(54) BI-METAL ASSEMBLING METHOD AND BI-METAL ASSEMBLED STRUCTURE

(71) Applicant: Ju Teng International Holdings Ltd., Hong Kong (HK)

(72) Inventors: Hsiang-Jui WANG, Taipei (TW); Shun-Jie YANG, Taipei (TW); Cheng-Ping HSIAO, Taipei (TW)

(21) Appl. No.: 16/837,407

(22) Filed: Apr. 1, 2020

(51) Int. Cl. B22D 19/16; B29C 45/00; B23P 15/24; B23H 5/04; B22D 21/04; B23P 15/00; C25D 11/04

(52) U.S. Cl. CPC B22D 19/16; B29C 45/0055; B23P 15/24; B29L 2031/34; B22D 21/04; B23P 15/007; C25D 11/04; B23H 5/04

(57) ABSTRACT

The present invention provides a bi-metal assembling method. The method provides a machine-shaped aluminum piece and places the machine-shaped aluminum piece into a die-cast mold. The machine-shaped aluminum piece is encapsulated with a magnesium metal liquid and die cast is performed. The assembled bi-metal structure is coated for protection and CNC high-gross treatment and anodizing treatment is performed in the machine-shaped aluminum piece. The magnesium alloy piece is hooked with the machine-shaped aluminum piece for assembling. The bi-metal structure has smooth surface to reduce the time for polishing, surface shrinkage and generation of blowholes. The present invention also provides a bi-metal assembled structure.

### BACKGROUND OF THE INVENTION

### 1. Technical Field

The present invention relates to a bi-metal assembling method and a bi-metal assembled structure.

### 2. Description of Prior Art

The present invention relates to a bi-metal assembling method and a bi-metal assembled structure.

The casing/shell of the electronic devices may include a plurality of structural elements. For example, the laptop computer may include display and main body. The display may include upper cover and display main body, while the main body may include keyboard cover and bottom structure. The above mentioned main body and keyboard cover may contain any suitable material.

The casing/shell of the electronic devices, such as casing of portable electronic devices, may be in frequent contact with other objects such as table, user hand, ground, magnesium alloy object such that the casing/shell of the electronic devices may have deformation. The casing/shell may be damaged, the cover paint of the casing/shell may be worn out and the protection layer may be broken due to collision or rub. The metallic object on casing/shell of the electronic devices may be rust-eaten such that it cannot provide protection function and is not appealing for consumer for appearance.

The shell generally adopts magnesium alloy with metallic gross, and the magnesium alloy is formed by electro-plating metal on the magnesium alloy surface to provide alloy with metallic gross. However, the magnesium in the magnesium alloy has high activity to render difficulty to the surface plating process. Therefore, the surface of the magnesium alloy is passivated to reduce activity and the process thereof is complicated.

### SUMMARY OF THE INVENTION

It is an object of the present invention to provide a bi-metal assembling method and a bi-metal assembled structure.

According to the first aspect of the present invention, a bi-metal assembling method is disclosed and includes providing a machine-shaped aluminum piece. The aluminum piece is placed in die-cast mold, encapsulated by magnesium liquid to fix the machine-shaped aluminum piece, and then die cast is performed such that the magnesium liquid forms a magnesium metal piece. After the bi-metal product (the magnesium metal piece assembled with the machine-shaped aluminum piece) is finished, the bi-metal product is coated for protection. Then the machine-shaped aluminum piece is further processed to form a structure (the structure is aperture or suitable for high gross treated), and then subject to CNC high-gross treatment and anodizing treatment. The coating can be achieved by lacquer coating or oxide layer coating. The magnesium alloy piece is hooked with the machine-shaped aluminum piece. The smooth surface of the product can reduce the time for polishing, the surface shrinkage and the generation of blowholes.

The magnesium liquid encapsulates the machine-shaped aluminum piece and then the magnesium liquid is hardened to form magnesium metal piece or magnesium alloy piece to fix the machine-shaped aluminum piece for die casting.

According to the first aspect of the present invention, a bi-metal assembled structure is disclosed and includes a machine-shaped aluminum piece encapsulated by a magnesium metal piece. The bi-metal product (the magnesium metal piece assembled with the machine-shaped aluminum piece) is coated for protection after assembling. The machine-shaped aluminum piece is processed to form a structure therein and the structure is subject to CNC high-gross treatment and anodizing treatment.

According to the second aspect of the present invention, a bi-metal assembling method is disclosed and includes providing a machine-shaped aluminum piece. The machine-shaped aluminum piece is pre-heated by a heater and then placed into die-cast mold, encapsulated by magnesium liquid to fix the aluminum piece, and then die cast is performed such that the magnesium liquid forms a magnesium metal piece, the magnesium metal piece is directly assembled with the aluminum piece. After the bi-metal product (the magnesium metal piece assembled with the machine-shaped aluminum piece) is finished, the bi-metal product is coated for protection. Then the machine-shaped aluminum piece is formed with a structure therein (the structure is aperture or a structure suitable for high gross treatment) and the structure is subject to CNC high-gross treatment and anodizing treatment. The coating can be achieved by lacquer coating or oxide layer coating. The magnesium alloy piece is directly assembled with the machine-shaped aluminum piece. The smooth surface of the product can reduce the time for polishing, the surface shrinkage and the generation of blowholes. The machine-shaped aluminum piece in this embodiment does not have projection on two sides thereof.

The magnesium/aluminum metal has diffusion assembling (similar to welding) in high temperature, where the heating temperature for aluminum piece is around 450˜500 centigrade. The aluminum metal piece is kept with high temperature in mold such that the magnesium metal piece can be directly assembled with the aluminum metal piece during casting.

The pre-heating temperature for the heater (before placing the machine-shaped aluminum piece into die-cast mold) is 450˜500 centigrade.

According to the second aspect of the present invention, a bi-metal assembled structure is disclosed and includes a machine-shaped aluminum piece encapsulated by a magnesium metal piece, where the magnesium metal piece and the machine-shaped aluminum piece are diffusion assembled in high temperature. The bi-metal product (the magnesium metal piece assembled with the machine-shaped aluminum piece) is coated for protection after assembling. The machine-shaped aluminum piece is processed to form a structure therein (the structure is aperture or a structure suitable for high gross treatment) and the structure is subject to CNC high-gross treatment and anodizing treatment.

The magnesium/aluminum metal has diffusion assembling (similar to welding) in high temperature, where the heating temperature for aluminum piece is around 450˜500 centigrade. The aluminum metal piece is kept with high temperature in mold such that the magnesium metal piece can be directly assembled with the aluminum metal piece during casting.

According to the third aspect of the present invention, a bi-metal assembling method is disclosed and includes providing an aluminum metal piece and a magnesium metal piece. The aluminum metal piece and the magnesium metal piece are separately formed and are subject to nano-treatment on surfaces thereof to form nanostructure on surface thereof. The aluminum metal piece and the magnesium metal piece are placed in the die-cast mold at the same time. Plastic is injected between the aluminum metal piece and the magnesium metal piece to form medium therebetween to assemble the two metal pieces. After the bi-metal product (the magnesium metal piece assembled with the machine-shaped aluminum piece) is finished, the bi-metal product is coated for protection. Then the machine-shaped aluminum piece is formed with a structure therein (the structure is aperture or a structure suitable for high gross treatment) and the structure is subject to CNC high-gross treatment and anodizing treatment. The smooth surface can reduce the time for polishing, the surface shrinkage and the generation of blowholes.

The nano-treatment can be performed by chemical etching or electro-chemistry film forming to form nano microstructure on the surface of the magnesium/aluminum metal piece. The plastic has binding force with metal (similar to hook-loop effect) after it is injected.

According to the third aspect of the present invention, a bi-metal assembled structure is disclosed and includes an aluminum metal piece and a magnesium metal piece, where both of the aluminum metal piece and the magnesium metal piece have nano-structure on surface thereof. The aluminum metal piece and the magnesium metal piece have plastic therebetween to function as medium therebetween to assemble the aluminum metal piece and the magnesium metal piece. The aluminum metal piece has a structure therein (the structure is aperture or a structure suitable for high gross treatment) and the structure is subject to CNC high-gross treatment and anodizing treatment.

The nano-treatment can be performed by chemical etching or electro-chemistry film forming to form nano microstructure on the surface of the magnesium/aluminum metal piece. The plastic has binding force with metal (similar to hook-loop effect) after it is injected.

According to the fourth aspect of the present invention, a bi-metal assembling method is disclosed and includes providing a machine-shaped aluminum piece. The machine-shaped aluminum piece is subject to nano-treatment on surfaces thereof to form nanostructure on surface thereof. The aluminum piece is placed in a die-cast mold and encapsulated by magnesium liquid to fix the aluminum piece, and then the magnesium liquid is die cast such that the magnesium liquid forms a magnesium metal piece, the magnesium metal piece is directly assembled with the aluminum piece and the nano-structure on the surface of the machine-shaped aluminum piece can increase surface contact area and enhance combining force. After the bi-metal product (the magnesium metal piece assembled with the machine-shaped aluminum piece) is finished, the bi-metal product is coated for protection. The aluminum metal piece has a structure therein (the structure is aperture or a structure suitable for high gross treatment) and the structure is subject to CNC high-gross treatment and anodizing treatment. The smooth surface can reduce the time for polishing, the surface shrinkage and the generation of blowholes.

The nano-treatment can be performed by chemical etching or electro-chemistry film forming to form nano microstructure on the surface of the magnesium/aluminum metal piece. The nano microstructure has binding force with metal (similar to hook-loop effect) after it is injected.

According to the fourth aspect of the present invention, a bi-metal assembled structure is disclosed and includes an aluminum metal piece and a magnesium metal piece, where the aluminum metal piece has nano-structure on surface thereof. The aluminum metal piece is encapsulated by the magnesium metal piece. The aluminum metal piece and the magnesium metal piece are assembled by the nano-structure on surface of the aluminum metal piece. The aluminum metal piece 41 has a structure (the structure is aperture or a structure suitable for high gross treatment) and the structure is subject to CNC high-gross treatment and anodizing treatment.

The nano-treatment can be performed by chemical etching or electro-chemistry film forming to form nano microstructure on the surface of the magnesium/aluminum metal piece. The plastic has binding force with metal (similar to hook-loop effect) after it is injected.

In above embodiments, the material for the aluminum metal alloy and magnesium metal alloy includes aluminum, magnesium, machine-shaped aluminum, aluminum piece, magnesium piece, aluminum metal piece, magnesium metal piece.

In the present invention, the inner wall of the structure of the aluminum metal piece can be subject to CNC high-gross treatment. The two metals can be combined with smooth surface, and the smooth surface can reduce the time for polishing, the surface shrinkage and the generation of blowholes. Besides, the invention also uses plastic, surface with nano-structure or directly assembling two metals to achieve the assembling of the two metals to form bi-metal assembling structure.

### BRIEF DESCRIPTION OF DRAWINGS

FIG. 1 shows the flowchart of the bi-metal assembling method according to the first embodiment of the present invention.

FIG. 2 shows the bi-metal assembled structure according to the first embodiment of the present invention.

FIG. 3 shows the flowchart of the bi-metal assembling method according to the second embodiment of the present invention.

FIG. 4 shows the bi-metal assembled structure according to the second embodiment of the present invention.

FIG. 5 shows the flowchart of the bi-metal assembling method according to the third embodiment of the present invention.

FIG. 6 shows the bi-metal assembled structure according to the third embodiment of the present invention.

FIG. 7 shows the flowchart of the bi-metal assembling method according to the fourth embodiment of the present invention.

FIG. 8 shows the bi-metal assembled structure according to the fourth embodiment of the present invention.

### DETAILED DESCRIPTION OF THE INVENTION

Reference will now be made to the drawing Figures to describe the present disclosure in detail. It will be understood that the drawing Figures and exemplified example of present disclosure are not limited to the details thereof.

The present invention has definition for certain processing terms as follows:

CNC Machine

Computer Numerical Control (CNC) machine is an automatic machine with program control system. The control system logically processes program with controlling code or other symbolic command to decode them into coded digits and input the coded digits into numerically-controlled device. The numerically-controlled device processes the coded digits to control manufacturing machine and processes the components automatically according to the designed shape and size. CNC machine can solve the problem of manufacturing components such as complexity, preciseness, small amount and large variety and so on. The CNC machine is a flexible and high-performance automatic machine and is a development trend for modern controlled machine as well as electromechanical integration technology.

High-Gross Machine

The machine is named after the processed product thereof. The appearance of the high-gross machine is similar to the engraving machine (or high-preciseness engraving machine). The spindle of the high-gross machine uses air floating spindle with 100000 RPM to achieve mirror face effect for the machined product thereof, while the knife patterns (HD-400G, HD-540G) are invisible. The current high-gross machine has some alias such as beveling machine, brim-shining machine or chamfer high-grossing machine. The high-gross machine has high demand for technology and has more demanding components then the ordinary engraving machine.

CNC high-gross machine can be used to machine various material such as acrylic, metal hardware, aluminum piece, aluminum material, copper piece and so on, and is suitable for mobile phone frame, mobile phone shell, television shell, high-gross camera focusing hardware, mobile phone button, mobile phone camera, mobile phone middle frame, ring, pendant, speaker, digital camera, 3D complicate metal hardware, metal decoration piece and so on. The high-gross machine can be used to machine can be used to process above products.

The CNC high-gross machine uses specialized knife, suitable cutting parameters and arts to realize shining machined surface arranged on the high-precision CNC equipment.

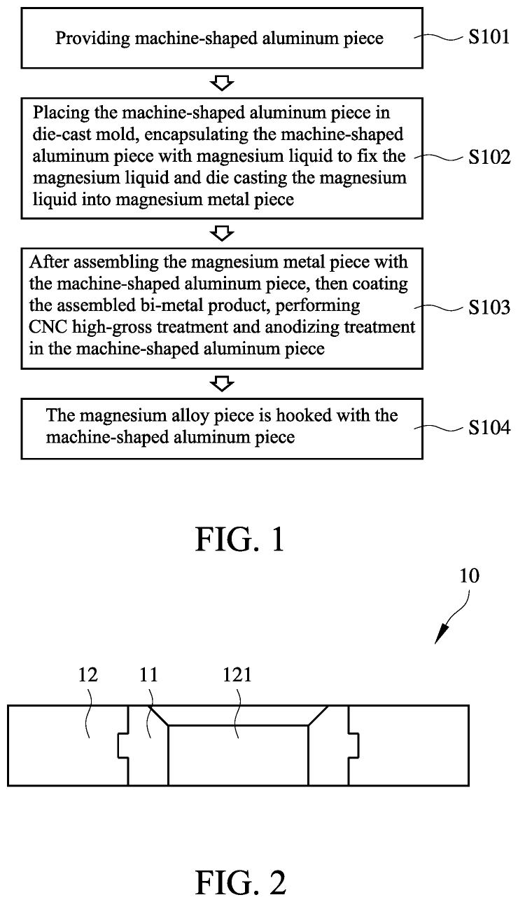

FIG. 1 shows the flowchart of the bi-metal assembling method according to the first embodiment of the present invention. The method includes providing a machine-shaped aluminum piece (S101). The aluminum piece is placed in die-cast mold, encapsulated by magnesium liquid to fix the machine-shaped aluminum piece, and then die cast is performed such that the magnesium liquid forms a magnesium metal piece (S102). After the bi-metal product (the magnesium metal piece assembled with the machine-shaped aluminum piece) is finished, the bi-metal product is coated for protection. Then the machine-shaped aluminum piece is further processed to form a structure (the structure is aperture or suitable for high gross treated), and then subject to CNC high-gross treatment and anodizing treatment (S103). The coating can be achieved by lacquer coating or oxide layer coating. The magnesium alloy piece is hooked with the machine-shaped aluminum piece (S104). The smooth surface can reduce the time for polishing, the surface shrinkage and the generation of blowholes.

The magnesium liquid encapsulates the machine-shaped aluminum piece and then the magnesium liquid is hardened to form magnesium metal piece or magnesium alloy piece to fix the machine-shaped aluminum piece for die casting.

The structure is aperture or a structure suitable for high gross treatment.

The machine-shaped aluminum piece has two projections respectively on two lateral sides thereof.

FIG. 2 shows the bi-metal assembled structure 10 according to the first embodiment of the present invention. The bi-metal assembled structure 10 includes a machine-shaped aluminum piece 11 encapsulated by a magnesium metal piece 12. The machine-shaped aluminum piece 11 has a structure 121. The bi-metal product (the magnesium metal piece assembled with the machine-shaped aluminum piece) is coated for protection after assembling and then is subject to CNC high-gross treatment and anodizing treatment in the structure 121. The machine-shaped aluminum piece has two projections respectively on two lateral sides thereof.

The structure is aperture or a structure suitable for high gross treatment.

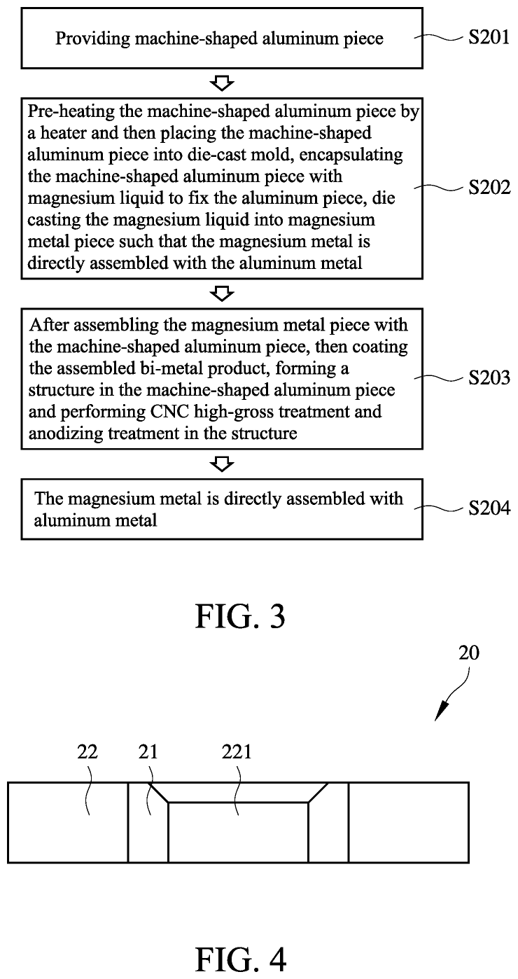

FIG. 3 shows the flowchart of the bi-metal assembling method according to the second embodiment of the present invention. The method includes providing a machine-shaped aluminum piece (S201). The machine-shaped aluminum piece is pre-heated by a heater and then placed into die-cast mold, encapsulated by magnesium liquid to fix the aluminum piece, and then die cast is performed such that the magnesium liquid forms a magnesium metal piece, the magnesium metal piece is directly assembled with the aluminum piece (S202). After the bi-metal product (the magnesium metal piece assembled with the machine-shaped aluminum piece) is finished, the bi-metal product is coated for protection. Then the machine-shaped aluminum piece is formed with a structure therein and the structure is subject to CNC high-gross treatment and anodizing treatment (S203). The coating can be achieved by lacquer coating or oxide layer coating. The magnesium alloy piece is directly assembled with the machine-shaped aluminum piece (S204). The smooth surface can reduce the time for polishing, the surface shrinkage and the generation of blowholes. The machine-shaped aluminum piece in this embodiment does not have projection on two sides thereof.

The magnesium/aluminum metal has diffusion assembling (similar to welding) in high temperature, where the heating temperature for aluminum piece is around 450˜500 centigrade. The aluminum metal piece is kept with high temperature in mold such that the magnesium metal piece can be directly assembled with the aluminum metal piece during casting.

The structure is aperture or a structure suitable for high gross treatment.

The pre-heating temperature for the heater (before placing the machine-shaped aluminum piece into die-cast mold) is 450˜500 centigrade.

FIG. 4 shows the bi-metal assembled structure 20 according to the second embodiment of the present invention. The bi-metal assembled structure 20 includes a machine-shaped aluminum piece 21 encapsulated by a magnesium metal piece 22, where the magnesium metal piece 22 and the machine-shaped aluminum piece 21 is diffusion assembled in high temperature. The machine-shaped aluminum piece 11 has a structure 121. The bi-metal product (the magnesium metal piece assembled with the machine-shaped aluminum piece) is coated for protection after assembling and then is subject to CNC high-gross treatment and anodizing treatment in the structure 121. The machine-shaped aluminum piece does not two projections respectively on two lateral sides thereof.

The magnesium/aluminum metal has diffusion assembling (similar to welding) in high temperature, where the heating temperature for aluminum piece is around 450˜500 centigrade. The aluminum metal piece is kept with high temperature in mold such that the magnesium metal piece can be directly assembled with the aluminum metal piece during casting.

The structure is aperture or a structure suitable for high gross treatment.

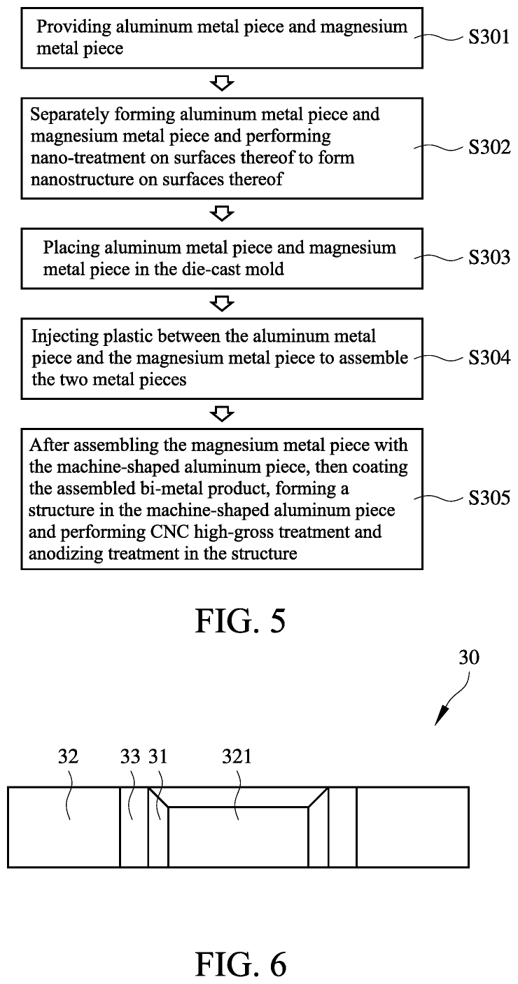

FIG. 5 shows the flowchart of the bi-metal assembling method according to the third embodiment of the present invention. The method includes providing an aluminum metal piece and a magnesium metal piece (S301). The aluminum metal piece and the magnesium metal piece are separately formed and are subject to nano-treatment on surfaces thereof to form nanostructure on surface thereof (S302). The aluminum metal piece and the magnesium metal piece are placed in the die-cast mold at the same time (S303). Plastic is injected between the aluminum metal piece and the magnesium metal piece to form medium therebetween to assemble the two metal pieces (S304). After the bi-metal product (the magnesium metal piece assembled with the machine-shaped aluminum piece) is finished, the bi-metal product is coated for protection. Then the machine-shaped aluminum piece is formed with a structure therein and the structure is subject to CNC high-gross treatment and anodizing treatment (S305). The coating can be achieved by lacquer coating or oxide layer coating. The smooth surface can reduce the time for polishing, the surface shrinkage and the generation of blowholes.

The nano-treatment can be performed by chemical etching or electro-chemistry film forming to form nano microstructure on the surface of the magnesium/aluminum metal piece. The plastic has binding force with metal (similar to hook-loop effect) after it is injected.

The structure is aperture or a structure suitable for high gross treatment.

The plastic is, for example, poly(phenylene sulfide) (PPS), polybutylene terephthalate (PBT), polyamides (PA) or other engineering plastic suitable for injection molding.

FIG. 6 shows the bi-metal assembled structure 30 according to the third embodiment of the present invention. The bi-metal assembled structure 30 includes an aluminum metal piece 31 and a magnesium metal piece 32, where both of the aluminum metal piece 31 and the magnesium metal piece 32 have nano-structure on surface thereof. The aluminum metal piece 31 and the magnesium metal piece 32 have plastic 33 therebetween to function as medium therebetween to assemble the aluminum metal piece 31 and the magnesium metal piece 32. The aluminum metal piece 31 has a structure 321 therein. After the bi-metal product (the magnesium metal piece assembled with the machine-shaped aluminum piece) is assembled, the bi-metal product is coated for protection and then is subject to CNC high-gross treatment and anodizing treatment in the structure 321.

The nano-treatment can be performed by chemical etching or electro-chemistry film forming to form nano microstructure on the surface of the magnesium/aluminum metal piece. The plastic has binding force with metal (similar to hook-loop effect) after it is injected.

The structure is aperture or a structure suitable for high gross treatment.

The plastic is, for example, poly(phenylene sulfide) (PPS), polybutylene terephthalate (PBT), polyamides (PA) or other engineering plastic suitable for injection molding.

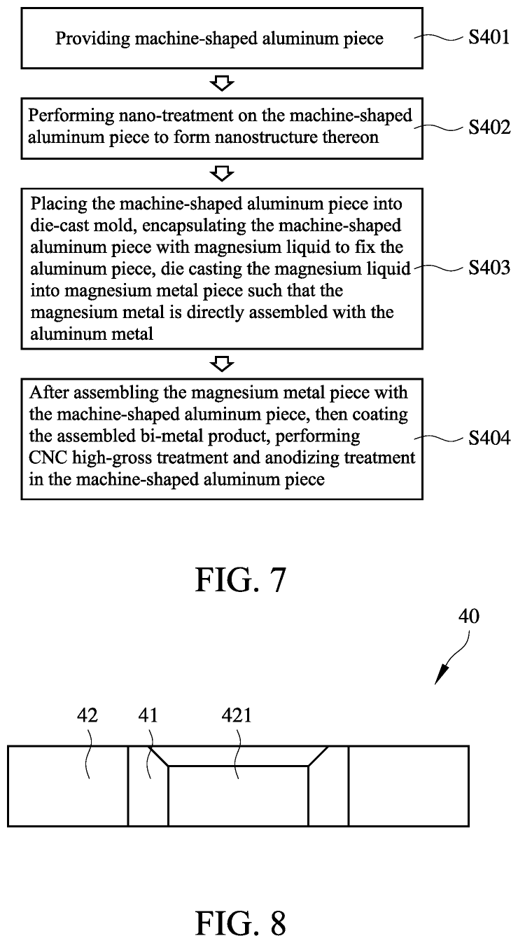

FIG. 7 shows the flowchart of the bi-metal assembling method according to the fourth embodiment of the present invention. The method includes providing a machine-shaped aluminum piece (S401). The machine-shaped aluminum piece is subject to nano-treatment on surfaces thereof to form nanostructure on surface thereof (S402). The aluminum piece is placed in a die-cast mold and encapsulated by magnesium liquid to fix the aluminum piece, and then the magnesium liquid is die cast such that the magnesium liquid forms a magnesium metal piece, the magnesium metal piece is directly assembled with the aluminum piece and the nano-structure on the surface of the machine-shaped aluminum piece can increase surface contact area and enhance combining force (S403). After the bi-metal product (the magnesium metal piece assembled with the machine-shaped aluminum piece) is finished, the bi-metal product is coated for protection. Then the machine-shaped aluminum piece is subject to CNC high-gross treatment and anodizing treatment (S404). The coating can be achieved by lacquer coating or oxide layer coating. The smooth surface can reduce the time for polishing, the surface shrinkage and the generation of blowholes.

The nano-treatment can be performed by chemical etching or electro-chemistry film forming to form nano microstructure on the surface of the magnesium/aluminum metal piece. The plastic has binding force with metal (similar to hook-loop effect) after it is injected.

The structure is aperture or a structure suitable for high gross treatment.

FIG. 8 shows the bi-metal assembled structure 40 according to the fourth embodiment of the present invention. The bi-metal assembled structure 40 includes an aluminum metal piece 41 and a magnesium metal piece 42, where the aluminum metal piece 41 has nano-structure on surface thereof. The aluminum metal piece 41 is encapsulated by the magnesium metal piece 42. The aluminum metal piece 41 and a magnesium metal piece 42 are assembled by the nano-structure on surface of the aluminum metal piece 41. The aluminum metal piece 41 has a structure 421. After the bi-metal product (the magnesium metal piece assembled with the machine-shaped aluminum piece) is assembled, the bi-metal product is coated for protection and then is subject to CNC high-gross treatment and anodizing treatment in the structure 421.

The nano-treatment can be performed by chemical etching or electro-chemistry film forming to form nano microstructure on the surface of the magnesium/aluminum metal piece. The plastic has binding force with metal (similar to hook-loop effect) after it is injected.

The structure is aperture or a structure suitable for high gross treatment.

In above embodiments, the material for the aluminum metal alloy and magnesium metal alloy includes aluminum, magnesium, machine-shaped aluminum, aluminum piece, magnesium piece, aluminum metal piece, magnesium metal piece.

In the present invention, the inner wall of the structure of the aluminum metal piece can be subject to CNC high-gross treatment. The two metals can be combined with smooth surface, and the smooth surface can reduce the time for polishing, the surface shrinkage and the generation of blowholes. Besides, the invention also uses plastic, surface with nano-structure or directly assembling two metals to achieve the assembling of the two metals to form bi-metal assembling structure.

Although the present invention has been described with reference to the preferred embodiment thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. A bi-metal assembling method, comprising:
providing a machine-shaped aluminum piece;
placing the machine-shaped aluminum piece into a die-cast mold, encapsulating the machine-shaped aluminum piece with a magnesium metal liquid to fix the aluminum piece, performing die cast such that the magnesium metal liquid forms a magnesium metal piece;
assembling the machine-shaped aluminum piece with the magnesium metal piece and coating the assembled machine-shaped aluminum piece and the magnesium metal piece for protection, performing computer numerical control (CNC) high-gross treatment and anodizing treatment to the machine-shaped aluminum piece;
wherein the magnesium alloy piece is hooked with the machine-shaped aluminum piece for assembling to reduce the time for polishing, surface shrinkage and generation of blowholes.

2. The method in claim 1, wherein the magnesium metal liquid encapsulates the machine-shaped aluminum piece and the magnesium liquid forms the magnesium metal piece to fix the machine-shaped aluminum piece for die cast.

3. A bi-metal assembled structure comprises a machine-shaped aluminum piece, a magnesium metal piece encapsulating the machine-shaped aluminum piece, and a structure in the machine-shaped aluminum piece, wherein the structure is subject to computer numerical control (CNC) high-gross treatment and anodizing treatment.

4. A bi-metal assembling method, comprising:
providing a machine-shaped aluminum piece;
preheating the machine-shaped aluminum piece and placing the machine-shaped aluminum piece into a die-cast mold, encapsulating the machine-shaped aluminum piece with a magnesium metal liquid to fix the aluminum piece, performing die cast such that the magnesium metal liquid forms a magnesium metal piece, the magnesium metal piece being formed in the die-cast mold such that aluminum metal and magnesium metal are directly assembled;
coating the assembled machine-shaped aluminum piece and the magnesium metal piece for protection and forming a structure in the machine-shaped aluminum piece, performing computer numerical control (CNC) high-gross treatment and anodizing treatment in the structure;
wherein the magnesium alloy piece is directly assembled with the machine-shaped aluminum piece to reduce the time for polishing, surface shrinkage and generation of blowholes.

5. The method in claim 4, wherein the aluminum metal and the magnesium metal have diffusion assembling in high temperature, the machine-shaped aluminum piece is pre-heated with temperature of 450˜500 centigrade, the machine-shaped aluminum piece is kept with high temperature in die-cast mold, the magnesium metal piece is directly assembled with the machine-shaped aluminum piece in die casting.

6. A bi-metal assembled structure comprises a machine-shaped aluminum piece, a magnesium metal piece encapsulating the machine-shaped aluminum piece such that the machine-shaped aluminum piece and the magnesium metal piece have diffusion assembling in high temperature, and a structure in the machine-shaped aluminum piece, wherein the structure is subject to computer numerical control (CNC) high-gross treatment and anodizing treatment.

7. The bi-metal assembled structure in claim 6, wherein the machine-shaped aluminum piece and the magnesium metal piece have diffusion assembling in high temperature, the machine-shaped aluminum piece is pre-heated with temperature of 450˜500 centigrade, the machine-shaped aluminum piece is kept with high temperature in die-cast mold, the magnesium metal piece is directly assembled with the machine-shaped aluminum piece in die casting.

8. A bi-metal assembling method, comprising:
providing an aluminum metal piece and a magnesium metal piece;
respectively shaping the aluminum metal piece and the magnesium metal piece, and respectively performing nano-treatment on surface of the aluminum metal piece and surface of the magnesium metal piece to respectively form a nano structure on the surface of the aluminum metal piece and the surface of the magnesium metal piece, placing the aluminum metal piece and the magnesium metal piece into a molding die such that the magnesium metal piece encapsulates the aluminum metal piece;
injecting a plastic between the magnesium metal piece and the aluminum metal piece as medium therebetween to assemble the magnesium metal piece with the aluminum metal piece; and
coating the assembled aluminum metal piece with the magnesium metal piece for protection and performing computer numerical control (CNC) high-gross treatment and anodizing treatment in the aluminum metal piece.

9. The method in claim 8, wherein the nano-treatment is performed by chemical etching or electro-chemistry film forming to form nano microstructure on the surface of the magnesium metal piece and the magnesium metal piece, the plastic has binding force with the aluminum metal piece and the magnesium metal piece after injection.

10. The method in claim 8, wherein the plastic is poly(phenylene sulfide) (PPS), polybutylene terephthalate (PBT), or polyamides (PA).

11. A bi-metal assembled structure comprises an aluminum metal piece and a magnesium metal piece, where both of the aluminum metal piece and the magnesium metal piece have nano structure on surface thereof, the magnesium metal piece encapsulating the aluminum metal piece, a plastic arranged between the aluminum metal piece and the magnesium metal piece to assemble the aluminum metal piece and the magnesium metal piece, the aluminum metal piece has a structure subject to computer numerical control (CNC) high-gross treatment and anodizing treatment.

12. The bi-metal assembled structure in claim 11, wherein the nano-treatment is performed by chemical etching or electro-chemistry film forming to form nano microstructure on the surface of the aluminum metal piece and the surface of the magnesium metal piece, the plastic has binding force with the aluminum metal piece and the magnesium metal piece after injection.

13. A bi-metal assembling method, comprising:
providing a machine-shaped aluminum piece;
nano-treating the machine-shaped aluminum piece to form a nano structure thereon;
placing the machine-shaped aluminum piece into a die-cast mold, encapsulating the machine-shaped aluminum piece with a magnesium metal liquid to fix the aluminum piece, performing die cast such that the magnesium metal liquid forms a magnesium metal piece and the magnesium metal piece being directly assembled with the aluminum piece, the nano structure on the aluminum piece increasing contact area to enhance combining force; and
after assembling the machine-shaped aluminum piece with the magnesium metal piece, coating the assembled machine-shaped aluminum piece and the magnesium metal piece for protection, forming a structure in the machine-shaped aluminum piece, performing computer numerical control (CNC) high-gross treatment and anodizing treatment in the structure.

14. The method in claim 13, wherein the nano-treatment is performed by chemical etching or electro-chemistry film forming to form nano microstructure on the surface of the machine-shaped aluminum piece.

15. A bi-metal assembled structure comprises an aluminum metal piece and a magnesium metal piece, where the aluminum metal piece has nano structure on surface thereof, the magnesium metal piece encapsulating the aluminum metal piece, the aluminum metal piece and the magnesium metal piece being assembled by the nano structure on the surface of the aluminum metal piece, the aluminum metal piece has a structure subject to computer numerical control (CNC) high-gross treatment and anodizing treatment.

16. The bi-metal assembled structure in claim 15, wherein the nano-treatment is performed by chemical etching or electro-chemistry film forming to form nano microstructure on the surface of the machine-shaped aluminum piece.
